(19) United States
(12) Patent Application Publication
(10) Pub. No.: US 2013/0107036 A1
(43) Pub. Date: May 2, 2013

(54) INSPECTION SYSTEM AND METHOD FOR CORRELATING DATA FROM SENSORS AND VISUAL DISPLAYS

(71) Applicant: Raymond Verle Jensen, Gardnerville, NV (US)

(72) Inventor: Raymond Verle Jensen, Gardnerville, NV (US)

(73) Assignee: General Electric Company, Schenectady, NY (US)

(21) Appl. No.: 13/284,065

(22) Filed: Oct. 28, 2011

(51) Int. Cl. H04N 7/18; G06K 9/00

(52) U.S. Cl. 348/135; 382/103; 348/E07.085

(57) ABSTRACT

Inspection systems and methods are described that can correlate different types of data and, more particularly, can associate data displayed visually on gauges with data collected by sensors disposed on an asset. In one embodiment, the inspection system comprises a camera that is positioned to capture an image of the gauge. The inspection system is further configured to identify a gauge value that is displayed by the gauges and captured in images. The inspection system is still further configured to generate an output signal to a data acquisition device, which uses the output signal to correlate the gauge value with data collected by the sensors.

### BACKGROUND OF THE INVENTION

The subject matter disclosed herein relates to inspection systems and, more particularly, to inspection systems that capture data from gauges with visual displays.

Machine monitoring and diagnostics can be seen as a decision-support tool which is capable of identifying the cause of failure in a machine component or system, as well as predicting its occurrence from a symptom. Without accurate detection and identification of the machine fault, maintenance and production scheduling cannot be effectively planned and the necessary repair tasks cannot be carried out in time. Therefore, machine monitoring and diagnostics are essential for an effective predictive maintenance program.

The ultimate goal of using machine monitoring and diagnostics is to increase equipment availability, and in addition, reduce maintenance and unexpected machine breakdown costs. In order to maximize availability, one has to increase reliability by maximizing the machine uptime and, at the same time, increase maintainability by minimizing the mean time to repair. As a result of monitoring and diagnostics, the frequency of unexpected machine breakdown is significantly reduced, and machine problems can be pinpointed immediately.

Machine monitoring and diagnostics can be done by simply listening to the sound generated during machine operation or visually examining the quality of machined parts to determine machine condition. However, many machine faults are not accurately assessed by relying only on visual or aural observations, especially during operation (e.g., wear and cracks in bearings and gearboxes). Therefore, more sophisticated signal processing techniques, such as vibration analysis, oil analysis, acoustic emission, infrared, and ultrasound, have been developed to help the maintenance technician and engineer detect and diagnose machine failures.

The discussion above is merely provided for general background information and is not intended to be used as an aid in determining the scope of the claimed subject matter.

### BRIEF DESCRIPTION OF THE INVENTION

An inspection system is disclosed, wherein the inspection system has features and components that collect and correlate data related to operating conditions (e.g., vibration) and operating parameters (e.g., running speed, power, temperature, etc.) of an asset. Data related to the operating parameters is often difficult to obtain because values for the operating parameters are only displayed visually. An advantage that may be realized in the practice of some disclosed embodiments of the inspection system is to detect values for the operating parameters from the visual displays.

In one embodiment, an inspection system is described that comprises an imaging device and a processor coupled to the imaging device. The inspection system also comprises memory coupled to the processor and comprising one or more executable instructions configured to be executed by the processor. The executable instructions comprise instructions for capturing an image of a gauge with the imaging device, the gauge displaying a gauge value for an operating parameter of an asset and for identifying the gauge value in the image. The executable instructions also include instructions for the gauge value a first value having units of measure and for generating an output signal reflecting the second value.

In another embodiment, an inspection system for monitoring an asset is described. The inspection system comprises a sensor sensitive to an operating condition of the asset. The inspection system also comprises a camera and a processing circuit coupled to the camera and operative to generate an output signal from an image of a gauge captured by the camera. In one example, the output signal has a value proportional to a gauge value displayed by the gauge and having units of measure compatible with a data acquisition device.

In yet another embodiment, there is described a method for monitoring an asset. The method comprises a step for receiving a first signal from an imaging device, the first signal transmitting image data of an image of a gauge. The method also comprises steps for identifying from the image data a gauge value that the gauge displays and for applying a scale factor to convert the gauge value from a first value to a second value. The method further comprises a step for converting the first signal to a second signal compatible with a data acquisition device that monitors one or more sensors disposed on the asset. In one example, the second value is compatible with a data acquisition device.

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of invention. In the drawings, like numerals are used to indicate like parts throughout the various views. Thus, for further understanding of the invention, reference can be made to the following detailed description, read in connection with the drawings in which:

FIG. 1 is a schematic diagram of an inspection system;

FIG. 2 is a flow diagram of an exemplary embodiment of a method for processing images into signals that reflect values displayed on a gauge;

FIG. 3 is a flow diagram of another exemplary embodiment of a method for gathering data about operation of an asset; and

FIG. 4 is a wiring diagram of an inspection system.

### DETAILED DESCRIPTION OF THE INVENTION

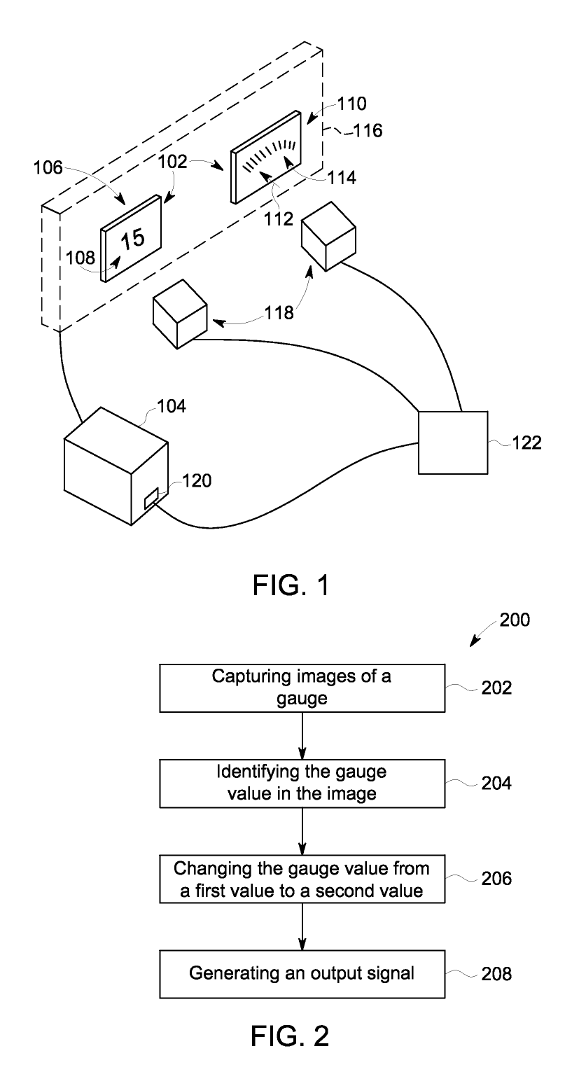

FIG. 1 illustrates an exemplary embodiment of an inspection system 100 with gauges 102 that visually display a gauge value, which quantifies an operating parameter for an asset 104. Exemplary operating parameters include running speed of a motor of the asset 104, as well as temperature, flow rate, and the like. The gauges 102 include a digital display 106 with a numeric readout 108 and a needle display 110 with a sweeping needle 112 and a scale 114. Other types of gauges may include bar scales, color indicators, and the like. The numeric readout 108 uses different types of characters (e.g., numbers and letters) to indicate the gauge value. The needle display 110 indicates the gauge value via the position of the sweeping needle 112 relative to the scale 114. The gauges 102 can be part of a control panel 116 or like control structure that includes hardware (and/or software and/or firmware) to control the asset 104.

The inspection system 100 may also include one or more imaging devices 118, (e.g., a camera), one or more sensors 120 (e.g., accelerometers), and a data acquisition device 122. The imaging devices are directed at the digital display 106 and the needle display 110. The sensors 120 are in position on and/or near the asset 104 to monitor certain operating conditions (e.g., vibration) of the asset 104 during operation. The sensors 120 transmit signals to a data acquisition device 122, which processes the signals for the purpose of gathering information about the operation of the asset 104. The signals have a sensor value that quantifies the operating condition. In one example, the data acquisition device 122 displays the signals on a screen (or display) for an end user (e.g., a technician) to view.

Embodiments of the inspection system 100 can associate the sensor values with the gauge values. This features alleviates the need for an end user to manually log the values on the gauges 102 and/or enter values into a data acquisition device. In one embodiment, the inspection system 100 uses the imaging devices 118 to capture one or more images of the digital display 106 and the needle display 110. However, the images comprise data that the data acquisition device 122 would ordinarily not be able to process. Thus, the image data, including the gauge value, is generally not compatible with the data acquisition device 122. To overcome this issue of compatibility, the inspection system 100 is equipped to identify the gauge value from the image data, thereby making the gauge value accessible to the data acquisition device 122. This feature may occur at one of the imaging devices 118 or a separately enabled device and or processing circuit (not shown) that can determine proper units of measure for the gauge value discussed herein. In one example, the inspection system 100 is equipped to generate an output signal that reflects the gauge value and that can be processed by and is compatible with the data acquisition device 122. The data acquisition device 122 can use this output signal to correlate the gauge value with information such as the sensor values the data acquisition device 122 receives from the sensors 120.

FIG. 2 depicts a flow diagram of a method 200 for processing the images into signals that the data acquisition device 122 can use. The method 200 includes, at block 202, capturing images of a gauge (e.g., the gauges 102) and, at block 204, identifying the gauge value in the image. The method 200 also includes, at block 206, determining from the gauge value a first value that has units of measure which can be processed by and are compatible with the data acquisition system 122. The method 200 further includes, at block 208, generating an output signal compatible with a data acquisition device (e.g., the data acquisition device 122).

Capturing images (e.g., at block 202) can occur on devices (e.g., the imaging devices 118) such as digital cameras. Other devices may include bar code readers and scanners, particularly those outfit with image sensors and technology to capture images. The devices can connect directly with the data acquisition device 122 and/or other devices that dictate operation of the cameras. Exemplary devices can capture single images and multiple images (e.g., video). For video applications, the inspection system 100 (e.g., via the imaging devices 118 and/or the data acquisition device 122) can process all or only a segment of the images that make up the video stream. Processing all of the images may be useful for implementations where the gauge value fluctuates rapidly and, thus, require more frequent sampling of images to accurately identify, collect, and correlate the gauge value to other data, e.g., the sensor values from the sensors 120. On the other hand, increasing the sampling time and/or capturing only a few images at certain intervals may be effective for applications where fluctuations in the gauge value are minimal.

Identifying the gauge value (e.g., at block 204) may depend on the type of gauge or, in one example, at least on the configuration of the display on the gauge. In one example, the method 200 includes steps to identify the characters of the gauge value (“the gauge value characters”) in the images. The method 200 may implement one or more data processing techniques such as optical character recognition (OCR) technique. These data processing techniques can translate the images into machine-encoded text, locate the gauge value characters within the resulting machine-encoded text, and quantify the gauge value that the combination of gauge value characters represents. When the gauge comprises instrumentation that displays the gauge value using a needle (e.g., the needle display 110) or providing one or more other physical representations of the gauge value, the data processing techniques may recognize the type of instrumentation and, based on the type of instrumentation, quantify the gauge value that the instrumentation displays. In one example, the method 200 can determine the position of a needle (e.g., the needle 112) relative to a scale (e.g., the scale 114) to quantify the gauge value.

Determining the first value (e.g., at block 206) simplifies correlation of the gauge value and the sensor value. By using units of measure that the data acquisition system expects and/or can process effectively scales the first value for processing. For example, often the gauge value and the sensor value have different units of measure. The gauge value may, for example, have units such as revolutions per minute (RPM), degrees Fahrenheit (F), or degrees Celsius (C). The sensor value may represent different levels of voltage, current, resistance, and the like depending on the type of sensor 120. One type of sensor may detect vibration and generate a signal that reflects relative levels of vibration as voltage in the range of, e.g., from 0V to 5V. In one embodiment, to normalize the gauge value and the sensor value, the method 200 may determine the first value so the resulting first value falls within the relative levels associated with the sensor value as expected by the data acquisition system. This step may ensure that the resulting output signal has a value that is proportional to, although different from, the gauge value that is displayed by the gauge.

There are various ways to achieve the normalization of the gauge value. In one example, the method 200 may implement a step for applying a scale factor, by which the gauge value is altered. In another example, the method 200 may implement a step for referencing a look-up table such as is reflected in Table 1 below.

TABLE 1

| Gauge | Normalized |
|---|---|
| Value | Gauge Value |
| (RPM) | (V) |
| 100 | 0 |
| 125 | 1 |
| 150 | 2 |
| 175 | 3 |
| 200 | 4 |

Determining the first value can occur automatically and/or by way of one or more data processing techniques. The data processing techniques may use look-up tables such as Table 1 above to assign the proper normalized gauge value. In the example of Table 1, the method 200 changes the gauge value of 100 RPM to a normalized gauge value of 0V. Look-up tables can be provided in connection with the type of asset the inspection system 100 monitors or based on other acceptable parameters as desired. In one embodiment, the method 200 may utilize data processing techniques that automatically identify features of the inspection system (e.g., the sensors and/or the asset) and/or other aspects of the testing environment. These features and aspects can dictate the content of the look-up table as well as any scale factor the method 200 uses to change the gauge value to the normalized gauge value.

Generating the output signal (e.g., at block 208), in this example, generates a signal the data acquisition device 122 (and/or other associated hardware) can readily process. Exemplary output signals can include digital signals and analog signals. In one embodiment, the method 200 may include steps for converting a first signal to a second signal, wherein the first signal originates from the imaging device 118. Conversion can occur from a digital signal to an analog signal, and vice versa. Construction of the imaging devices 118, the sensors 120, and the data processing device 122, as well as other factors, may dictate the characteristics of the various signals that transmit information about the inspection system. It is also foreseeable that certain embodiments of the inspection system 100 may forgo converting of the first signal altogether. For example, the imaging devices 118 may generate signals that the data acquisition device 122 may be able to process.

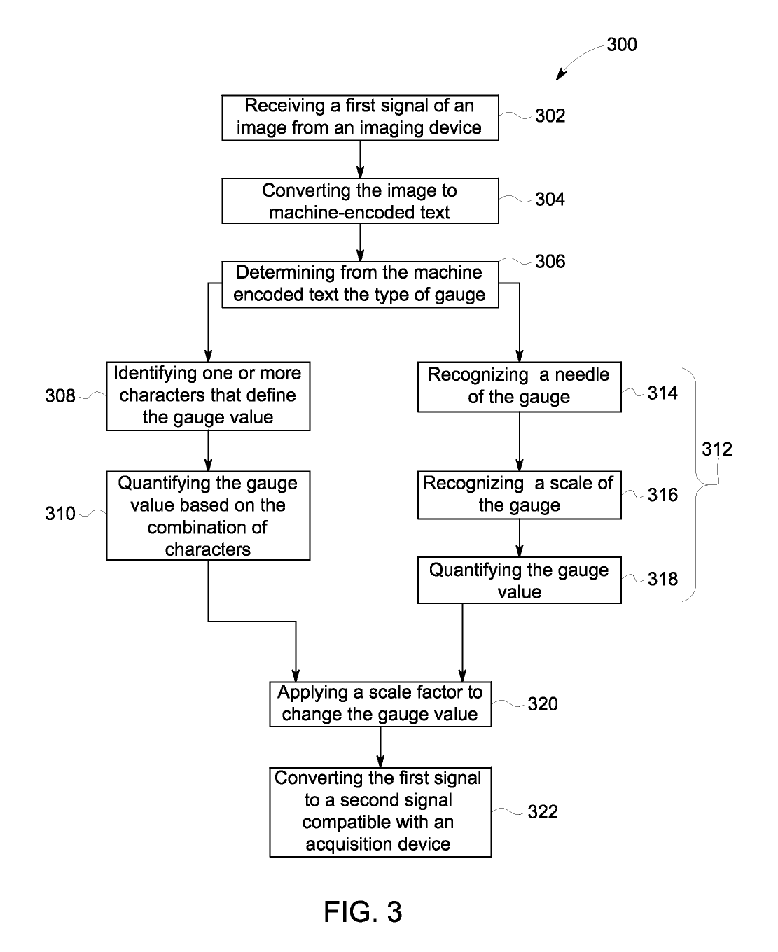

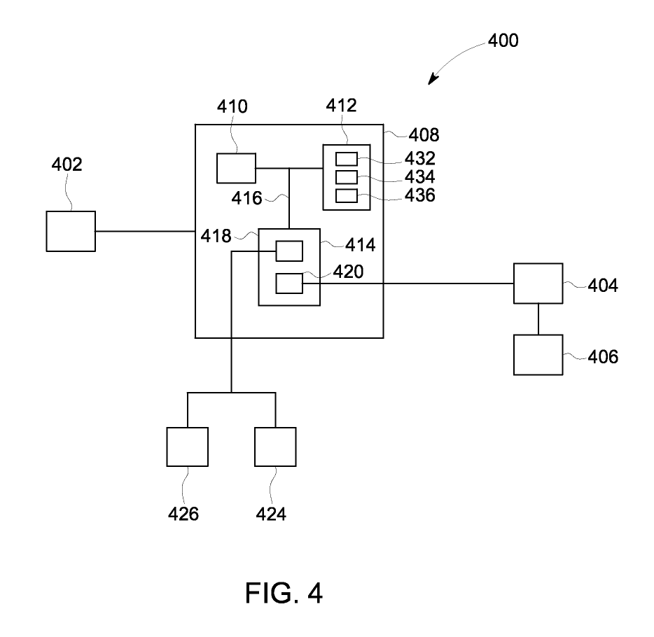

FIG. 3 illustrates another exemplary embodiment of a method 300, which is useful for gathering data about the operation of an asset. The method 300 includes, at block 302, receiving a first signal of an image from an imaging device and, at block 304, converting the image to machine-encoded text. The method 300 also includes, at block 306, determining from the machine-encoded text the type of gauge. For example, at block 308, if the gauge has a numeric readout, then the method 300 continues, at block 310, identifying one or more characters that define the gauge value and, at block 312, quantifying the gauge value based the combination of characters.

On the other hand, at block 314, if the gauge comprises instrumentation with a physical indication (e.g., needle and scale), then the method 300 continues, at block 316, determining the gauge value displayed by the instrumentation. For example, the method 300 can include, at block 318, recognizing a needle of the gauge, at block 320, recognizing a scale of the gauge, and, at block 322, quantifying the gauge value based on the position of the needle relative to the scale. The method 300 further includes, at block 324, applying a scale factor to change the gauge value from a first value to a second value and, at block 326, converting the first signal to a second signal compatible with a data acquisition device.

FIG. 4 illustrates a high-level wiring schematic of an inspection system 400. Generally a variety of configurations can implement the concepts of the present disclosure. The example of FIG. 4 provides a schematic diagram of one exemplary structure. In the present example, the inspection system 400 includes an imaging device 402, a data acquisition device 404, and a sensor 406. The inspection system 400 also includes a control circuit 408 with a processor 410, a memory 412, and a component circuit 414, all connected by a bus 416. The component circuit 414 can include a display driver circuit 418 and a converter circuit 420. Examples of the converter circuit 422 can include various digital-to-analog converters, analog-to-digital converters, and the like. The inspection system 400 also includes a display 424 and a computing device 426 (e.g., a laptop, smartphone, and/or handheld device). Also shown in FIG. 4, the memory 412 can store one or more computer programs or executable instructions in the form of, for example, instructions 432 for optical character recognition, instructions 434 for scaling, and instructions 436 for configuring the control circuit 408. Examples of these instructions and data processing techniques are provided in connection with FIGS. 2 and 3 discussed above. The steps of the methods 200 and 300 can be provided as executable instructions, which the components of the control circuit 408 and/or the inspection system 400 can execute to implement and, ultimately, generate the signals disclosed herein.

Although shown as individual units, variations of construction can combine one or more components of the control circuit 408, e.g., with the camera 402 and/or the data acquisition device 404. In one example, the processor 410 is a central processing unit (CPU) such as an ASIC and/or an FPGA. The processor 410 can also include state machine circuitry or other suitable components capable of receiving inputs from the component circuitry 414, imaging device 402, directly from the sensor 406, and/or other components (e.g., the computing device 426). The memory 412 comprises volatile and non-volatile memory and can be used for storage of software (or firmware) instructions and configuration settings. In some embodiments, the processor 410, the memory 412, and the circuitry 408 can be contained in a single integrated circuit (IC) or other component. As another example, the processor 410 can include internal program memory such as RAM and/or ROM. Similarly, any one or more of functions of these components can be distributed across additional components (e.g., multiple processors or other components).

In view of the foregoing, embodiments of the inspections systems are configured to locate and identify values in images. A technical effect is to simplify the correlation of data collected from sensors, which monitor operating conditions of the asset, with data displayed or provided by gauges, e.g., located on a control panel.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “service,” “circuit,” “circuitry,” “module,” and/or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code and/or executable instructions embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer (device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

As used herein, an element or function recited in the singular and proceeded with the word “a” or “an” should be understood as not excluding plural said elements or functions, unless such exclusion is explicitly recited. Furthermore, references to “one embodiment” of the claimed invention should not be interpreted as excluding the existence of additional embodiments that also incorporate the recited features.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An inspection system, comprising:
an imaging device;
a processor coupled to the imaging device; and
memory coupled to the processor and comprising one or more executable instructions configured to be executed by the processor, the executable instructions comprising instructions for:
capturing an image of a gauge with the imaging device, the gauge displaying a gauge value for an operating parameter of an asset;
identifying the gauge value in the image;
determining from the gauge value a first value having units of measure which are compatible with a data acquisition device; and
generating an output signal reflecting the first value.

2. The inspection system of claim 1, further comprising instructions for:
translating the image into machine-encoded text; and
locating characters of the gauge value in the machine-encoded text.

3. The inspection system of claim 1, further comprising instructions for quantifying the gauge value from a physical representation of the gauge value, wherein the gauge comprises instrumentation that provides a physical representation of the gauge value.

4. The inspection system of claim 3, further comprising instructions for determining a position of a needle relative to a scale, wherein the position reflects the gauge value.

5. The inspection system of claim 1, further comprising instructions for accessing a look-up table that determines the first value.

6. The inspection system of claim 1, wherein the output signal comprises an analog signal.

7. The inspection system of claim 1, wherein the output signal comprises a digital signal.

8. The inspection system of claim 1, further comprising one or more sensors coupled to the data acquisition device, wherein the sensors capture data for a sensor value that is compatible with the data acquisition device.

9. The inspection system of claim 8, wherein the sensors comprise an accelerometer.

10. The inspection system of claim 1, wherein the imaging device comprises a digital camera.

11. An inspection system for monitoring an asset, said inspection system comprising:
a sensor sensitive to an operating condition of the asset;
a camera; and
a processing circuit coupled to the camera and operative to generate an output signal from an image of a gauge captured by the camera,
wherein the output signal has a value proportional to a gauge value displayed by the gauge and having units of measure compatible with a data acquisition device.

12. The inspection system of claim 11, further comprising a digital-to-analog converter, wherein the output signal comprises an analog signal.

13. The inspection system of claim 11, further comprising an analog-to-digital converter, wherein the output signal comprises a digital signal.

14. The inspection system of claim 11, wherein the data acquisition device couples to the sensor and the processing circuit, and wherein the data acquisition device can display data representative of the output signal and a signal from the sensor.

15. The inspection system of claim 11, wherein the processing circuit comprises executable instructions for optical character recognition, wherein execution of the instructions identifies the gauge value in the image.

16. A method for monitoring an asset, said method comprising steps for:
receiving a first signal from an imaging device, the first signal transmitting image data of an image of a gauge;
identifying from the image data a gauge value that the gauge displays;
applying a scale factor to convert the gauge value from a first value to a second value; and
converting the first signal to a second signal compatible with a data acquisition device that monitors one or more sensors disposed on the asset,
wherein the second value is compatible with a data acquisition device.

17. The method of claim 16, further comprising steps for determining from the image data the type of gauge.

18. The method of claim 17, wherein the gauge comprises a digital readout the displays the gauge values with one or more characters.

19. The method of claim 16, further comprising steps for identifying one or more characters that define the gauge value.

20. The method of claim 16, further comprising steps for:
recognizing a needle of the gauge;
recognizing a scale of the gauge; and
quantifying the gauge value based on the position of the needle relative to the scale.
